(19) United States
(12) Patent Application Publication
(10) Pub. No.: US 2002/0178444 A1
(43) Pub. Date: Nov. 28, 2002

(54) Background commercial end detector and notifier

(75) Inventors: Miroslav Trajkovic, Ossining, NY (US); Srinivas Gutta, Buchanan, NY (US); Antonio Colmenarez, Peekskill, NY (US)

Correspondence Address: Michael E. Marion, Corporate Patent Counsel, U.S. Philips Corporation, 580 White Plains Road, Tarrytown, NY, 10591, US

(73) Assignee: Koninklijke Philips Electronics N.V.

(21) Appl. No.: 09/862,278

(22) Filed: May 22, 2001

(51) Int. Cl. H04N 7/10; H04N 7/025

(52) U.S. Cl. 725/32; 725/36

(57) ABSTRACT

Provided is an apparatus and method for notifying the completion of a commercial in a channel selected by a viewer. The system includes a segment detector coupled to receive incoming channel signals from a plurality of sources and for determining the beginning and end of commercials within a particular channel; at least one tuner for receiving the incoming channel signals and for decoding them for display in a television unit; and, a controller for notifying the completion of commercials from the channel designated by the viewer. Accordingly, when commercials are ended in one channel while viewing another channel, the viewer is notified of such completion and has an option to switch back to the desired channel.

### BACKGROUND OF THE INVENTION

1. Field of the Invention

The present invention relates to an information control system, more particularly, to a method and apparatus for notifying a user when commercials from a particular channel are completed while the user is viewing a different channel.

2. Description of Related Art

The modem world with huge amounts of multimedia content and varied delivery options gives us a tremendous variety and range of options and choices. Currently, over 500 different program channels are shown through a variety of service mediums, including satellite dishes, coax cable, telephone lines, fiber optic cable, and television broadcast. In order to view different TV signals, most viewers often spend a lot of time “channel surfing,” trying to find something he or she is interested in watching. This channel surfing is rampant especially during commercial breaks. Typically, an average of four to five commercials are shown, and if a viewer does not like a particular commercial, he or she will either tune to another channel or browse the channels hoping to avoid the undesirable commercial. However, often the viewer will miss the exact duration of the undesirable commercials and miss part of the show upon returning to it. Hence, the untimely channel switching causes viewers to miss important or interesting information. Accordingly, there is a need to allow an exact timing of switching back to continue watch the desired program to minimize the associated frustration.

### SUMMARY OF THE INVENTION

The present invention is directed to a method and apparatus for notifying a viewer to switch back to a desired channel program when the commercials broadcast in that channel are completed.

The present invention provides an apparatus that is capable of notifying the completion of a commercial selected by a viewer and includes a receiver circuit for receiving incoming television signals; a segment detector for determining the beginning and ending of the commercial; at least one tuner for decoding the incoming television signals; and, a controller for notifying the viewer of the end of commercial from the channel selected by said viewer.

The present invention provides a method of notifying the completion of a commercial selected by a viewer and is performed according to the following steps: transmitting a request to switch from one television program to another; transmitting a message indicating the completion of said commercial to the viewer who is viewing another program; and, selectively switching back to the channel desired by the viewer.

### BRIEF DESCRIPTION OF THE DRAWINGS

A more complete understanding of the method and apparatus of the present invention may be had by reference to the following detailed description when taken in conjunction with the accompanying drawings wherein:

FIG. 1 illustrates a simplified block diagram of the system according to an embodiment of the present invention;

FIG. 2 illustrates a channel control system according to an embodiment of the present invention;

FIG. 3 illustrates an automatic switching operation between a plurality of channels according to the present invention;

FIG. 4 is a flow chart showing the operation steps in notifying the viewer to switch back to a channel selected by a viewer according the present invention; and, FIG. 5 depicts a simplified block diagram of the display screen upon being notified by the inventive system to switch back to the channel selected by a user.

### DETAILED DESCRIPTION OF THE PREFERRED EMBODIMENT

In the following description, for purposes of explanation rather than limitation, specific details are set forth such as the particular architecture, interfaces, techniques, etc., in order to provide a thorough understanding of the present invention. However, it will be apparent to those skilled in the art that the present invention may be practiced in other embodiments, which depart from these specific details. Moreover, for the purpose of clarity, detailed descriptions of well-known devices, circuits, and methods are omitted so as not to obscure the description of the present invention with unnecessary detail.

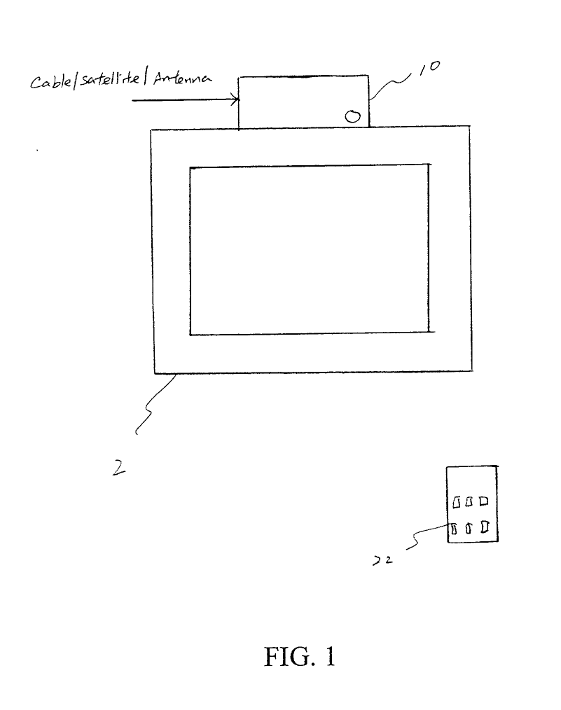

FIG. 1 is a functional block diagram of a control system 10, which is capable of notifying a viewer of the completion of commercials from the channel selected by the viewer while the viewer is browsing between channels/programs in accordance with an exemplary embodiment of the present invention. As shown in FIG. 1, the control system 10 receives broadcast signals from an antenna, cable source, and satellite and transmits them to a TV unit 2 for display. A remote controller 22 is provided to transmit command signals from a viewer to the control system 10. Although the control system 10 is coupled to the TV unit 2 for illustrative purposes, it is to be understood that the control system 10 can be implemented as one TV unit 2. In addition, it is to be understood that the present invention is capable of receiving signals from other different systems (i.e., telephone line, optical fiber, manual input median, recorded medium, etc.) or broadcast providers. Thus, the number of input signal sources in the drawing should not impose limitations on the scope of the invention.

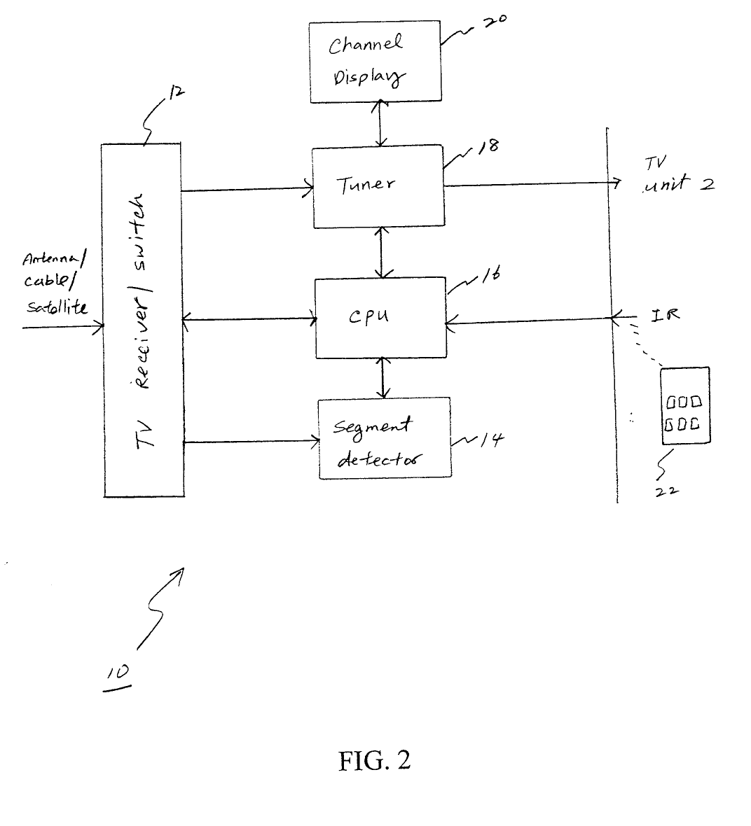

Referring to FIG. 2, major components of the control system 10 include a TV receiver/switch 12, a segment detector 14, a CPU 16, a tuner circuitry 18, and a channel display 20. The function of the receiver/switch circuitry 12 is to demodulate and decode incoming channel signals, which include video and audio information, from various sources on the given system. The CPU 16 causes the receiver/switch circuitry 16 to couple one of these decoded channel signals to the tuner circuitry 18 in response to a user input (i.e., a channel change request or surfing through various available channels). Thereafter, the output of the tuner circuitry 16 is forwarded to the TV unit 2 for display. Those skilled in the art will readily understand that the driving circuitry may be incorporated into the television set as a means to pump signals into the display screen of the TV unit 2 using any one of a number of standard techniques. The function of the segment detector 14 is to determine the duration of commercial breaks between programs. The function of the channel display 20 is to display the identification of the channel displayed on the TV unit 2, as well as transmitting a message to the viewer of the completion of commercials from a channel selected by the viewer. It should be noted detecting the beginning and the end of commercial blocks within a television signal is well known in the art that can be performed in a variety of ways. See for example, U.S. patent Ser. No. 05/151,788 filed on Jan. 26, 1989 and issued on Sep. 29, 1992, the content of which is hereby incorporated by reference.

An infrared (IR) remote controller 22 is also provided to communicate with the CPU 14 to issue instructions selected by the viewer to the CPU 14. Here, the remote controller 22 comprises conventional channel changing buttons in the form of a numeric keypad, a volume control button, and an up channel/down channel button. In the operation mode, if the transmitted signal from the remote controller 22 involves channel-switching information, the number of the selected channel is displayed on the channel display 20. If the transmitted signal involves other control signals such as a volume control or TV operating settings, the CPU 16 informs the appropriate control circuits (not shown) of the control system 10 to operate.

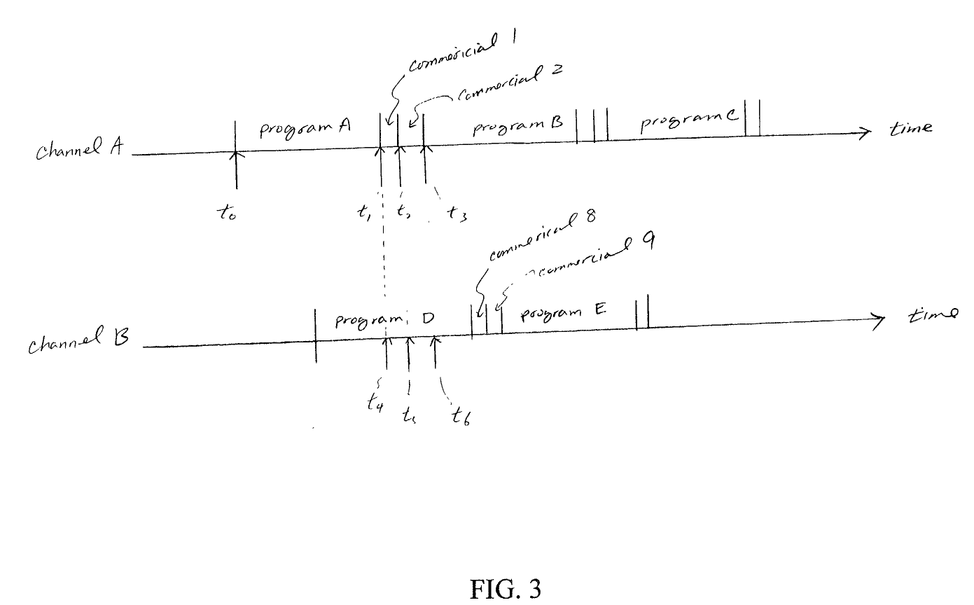

In operation, using the remote controller 22, the viewer specifies a particular channel at the end of the program using the remote controller 22 to be notified of the completion of a plurality of commercials prior showing the next segment of the program. For example, channel station 4, which is showing a football game is designated by the viewer while the viewer changes to a different channel during commercials. To accomplish this, the segment detector 14, as shown in FIG. 3, detects the duration of commercials between program segments for different channels. In this manner, each channel signal from multiple sources is associated with a time pointer to indicate the beginning and end of a commercial during commercial breaks. When the viewer changes from Channel A to Channel B at time t1 and requests the control system 10 to notify the end of the commercial block at time t3 while watching Channel B or other channels, the CPU 16 controls the output of the tuner 18 and the receiver/switch circuitry 12 to decode and select Channel B for display to the viewer. Then at time t3, it notifies the viewer of the end of the commercial. At this time, the viewer can selectively switch back to Channel A using the remote controller 22, or the control system 10 can be programmed to automatically make the switch back to Channel A. Hence, the viewer can simply press a channel number key or designated key, such as a page down key (i.e., scroll down key), for the desired channel program to be displayed at the end of the commercial break, while watching or browsing other channels.

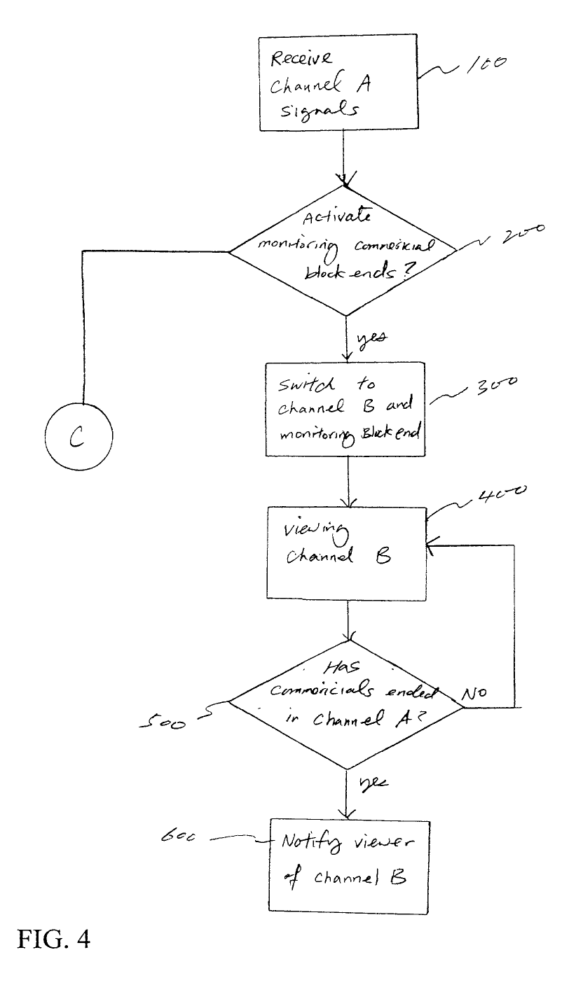

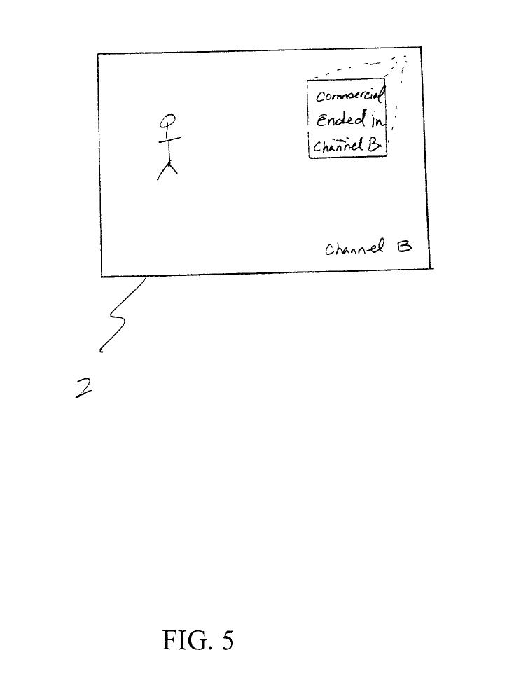

FIG. 4 is a flow chart illustrating the method of notifying the viewer of the end of commercials described above. Referring to FIG. 4, the initial set-up of notifying the viewer may be triggered by an auto set-up routine, which detects incoming channel signals and identifies the beginning and end of commercial breaks, as shown in FIG. 3, in step 100. Step 200 determines whether the viewer has activated the automatic notification mode to detect the end of commercial blocks in Channel A. To achieve this, instructions can be inputted directly by operating various keys on an IR remote controller 22. In step 300, the remote controller 20 will transmit channel switch instruction signal to the CPU 16, and in step 400, Channel B is displayed to the viewer. Thereafter, in step 500, when commercials from Channel A are completed, the CPU 16 causes the channel display 20 to notify the viewer of the end of commercials, as shown in FIG. 5. It is noted that various conventional methods of notifying the viewer can be implemented. Alternatively, the switch back to Channel A selected by the viewer can be performed automatically if such a mode is selected by the viewer using the remote controller 22.

It is apparent from the foregoing that the method and apparatus according to the present invention provide advantages by allowing the viewer not to miss a desired program while browsing other channels. Accordingly, the viewer simply tunes to a single station, then changes the channel as desired without the inconvenience of having to manually switch between channels, hoping not to miss any portion of the desired program.

While the preferred embodiments of the present invention have been illustrated and described, it will be understood by those skilled in the art that various changes and modifications may be made, and equivalents may be substituted for elements thereof without departing from the true scope of the present invention. In addition, many modifications may be made to adapt to a particular situation and the teaching of the present invention without departing from the central scope. Therefore, the intent of the present invention is not be limited to the particular embodiment disclosed as the best mode contemplated for carrying out the present invention; instead, the present invention includes all embodiments falling within the scope of the appended claims.

What is claimed is:

1. An apparatus for notifying the completion of a commercial in a channel selected by a viewer, comprising:
a segment detector coupled to receive incoming channel signals from a plurality of sources and for determining the beginning and ending of said commercial within said channel signals;
at least one tuner coupled to receive said incoming channel signals, said tuner being operative for decoding the output signals received thereon; and,
a controller coupled to said segment detector and said tuner, said controller being operative for notifying the completion of said commercial in said channel selected by said viewer.

2. The apparatus of claim 1, further comprising a remote control device for transmitting a viewer's request to said controller.

3. The apparatus of claim 1, further comprising a channel display for displaying at least one channel number representing said channel selected by said viewer and for displaying a message indicating the completion of said commercial.

4. The apparatus of claim 1, wherein the output signals of said tuner is coupled to a television unit for display.

5. The apparatus of claim 1, wherein said incoming channel signals are transmitted from the group consisting of a cable, antenna, satellite, telephone line, optical fiber, manual input median, and recorded medium.

6. A method for notifying the completion of a commercial in a channel selected by a viewer, the method comprising the steps of:
receiving a plurality of television programs;
transmitting a request to switch from one television program to another television program selected by a viewer;
displaying said another television program to said viewer;
transmitting a message indicating the completion of said commercial to said viewer; and,
forwarding said retrieved television program to said television system for display.

8. The method of claim 6, further comprising the step of transmitting a switch signal to return to said one television program.

9. The method of claim 6, wherein the receiving step receives said television programs from the group consisting of a cable, antenna, satellite, telephone line, optical fiber, manual input median, and recorded medium.

10. An apparatus for notifying the completion of a commercial in a channel selected by a viewer, comprising:
a receiver circuit coupled to receive incoming television signals;
a segment detector for determining the beginning and end of said commercial within said television signals;
at least one tuner coupled to receive said incoming television signals from said receiver circuit, said tuner being operative for decoding said received television signals; and,
a controller coupled to said receiver circuit, said tuner, and said segment detector, said controller being operative for retrieving output signals representing a program selected by said viewer, and for notifying said viewer of the completion of said commercial in said channel selected by said viewer.

11. The apparatus of claim 10, wherein the output signals of said tuner is coupled to a television unit for display.

12. The apparatus of claim 10, further comprising a channel display for displaying a message indicating the completion of said commercial.

13. The apparatus of claim 10, further comprising a remote control device for transmitting a viewer's request to said controller.

14. The apparatus of claim 10, wherein said receiver circuit receive said incoming television signals from the group consisting of a cable, antenna, satellite, telephone line, optical fiber, manual input median, and recorded medium.

15. A method for notifying the completion of a commercial in a channel selected by a viewer, the method comprising the steps of:
receiving a plurality of television programs;
enabling said viewer to designate said channel to be notified of the completion of said commercial via a remote control device;
transmitting a request to switch from one television program to another program selected by said viewer;
switching, in response to said viewer, from said one television program to said another program;
transmitting a message indicating the completion of said commercial to said viewer; and,
generating a switch signal using said remote control device to return to said one television program.

16. The method of claim 15, wherein the receiving step receives said television programs from the group consisting of a cable, antenna, satellite, telephone line, optical fiber, manual input median, and recorded medium.
